(19) United States
(12) Patent Application Publication
(10) Pub. No.: US 2007/0218863 A1
(43) Pub. Date: Sep. 20, 2007

(54) Wireless communication system, wireless communication method, and signal processing program therefor

(75) Inventors: Yasunori Futatsugi, Tokyo (JP); Tomozou Tanaka, Tokyo (JP)

Correspondence Address: Paul J. Esatto, Jr.;Scully, Scott, Murphy & Presser, Suite 300, 400 Garden City Plaza, Garden City, NY, 11530, US

(73) Assignee: NEC Corporation, Tokyo (JP)

(21) Appl. No.: 11/716,847

(22) Filed: Mar. 12, 2007

(30) Foreign Application Priority Data
Mar. 16, 2006 (JP) 2006-072606

(51) Int. Cl. H04Q 7/20; H04M 11/00

(52) U.S. Cl. 455/403

(57) ABSTRACT

To achieve a wireless communication apparatus capable of lowering power consumption for a digital signal processing of a transmitter in response to a transmission path condition.

A wireless communication system performs communication by digital transmission or analog transmission of a signal processed by a digital signal processing unit in a transmitting section on a transmission side toward a reception side through a line, wherein a transmission path condition of the line is measured on the reception side, the transmission path condition is transmitted to the transmission side using a reverse line with respect to the above described line, and a bit width for signal processing of digital signal processing units such as a modulating unit and a digital/analog converting unit is varied by a bit width selecting unit in response to the transmission path condition of the line notified by the reverse line on the transmission side.

### BACKGROUND OF THE INVENTION

1. Field of the Invention

The present invention relates to a wireless communication system, a wireless communication apparatus, a wireless communication method, and a signal processing program therefor in performing wireless communication by an analog transmission system and a digital transmission system, wherein, in particular, signal bit width is varied according to a condition of a transmission path on a digital signal processing at a transmitting section.

2. Description of the Related Art

Wireless transmission systems using light or electromagnetic waves for carrier waves are classified broadly into an analog transmission system and a digital transmission system. The wireless transmission is achieved by a wireless transceiver in which a modulation/demodulation processing is performed by a computer having an analog circuit or a digital circuit, and a control program.

FIG. 19 shows an example of a receiver in a conventional wireless communication apparatus (the publication of Japanese Patent Application Laid-open No. 2001-257731, Patent Document 1). According to Patent Document 1, after a signal transmitted from a transmitter is received, an AD converting unit 1801 samples the received baseband signal A converted into a baseband signal at a certain frequency, then converts it into a digital signal with a certain bit width. A high-frequency component is eliminated from the converted digital signal at a filtering unit 1802, then the digital signal is demodulated at a demodulating unit 1803 into a reception information sequence Bk.

An error detective unit 1804 calculates an error rate of the reception information sequence Bk and outputs it to a control unit 1805. The control unit 1805 determines bit widths of the AD converting unit 1801, the filtering unit 1802, and the demodulating unit 1803 in response to a comparative result between the error rate calculated by the error detective unit 1804 and a target error rate set for each application.

FIG. 20 is a flow chart showing the set of operations above.

In FIG. 20, the AD converting unit 1801 samples the received baseband signal A, which is an analog signal, at a certain frequency, and converts it into a digital signal with a certain bit width in Step S1901. Then, a high-frequency component is eliminated from the converted digital signal by the filtering unit 1802 in Step S1902.

In the next step, S1903, the demodulation unit 1803 demodulates the signal from which the high-frequency component is removed, so that a reception information sequence Bk is obtained. The error detective unit 1804 calculates an error rate of the reception information sequence Bk so as to compare the calculated error rate with the target error rate set for each application in Step 1904.

Then, the error rate is determined in Step S1910 whether it is lower than the target error rate or not, and when it is lower, a comparative processing is performed in Step S1911 where a current bit width is compared with a lower limit bit width. When the error rate is not lower than the target error rate, a comparative processing is performed in Step 1912 where the current bit width is compared with a upper limit bit width.

When the error rate is lower than the target error rate and the bit width is greater than the lower limit, the bit width is reduced by 1-bit in Step 1913, and when the bit width is not greater than the lower limit, the operations conclude without changing the bit width. When the error rate is not lower than the target error rate and the bit width is smaller than the upper limit, the bit width is extended by 1-bit in Step 1914, and when the bit width is not smaller than the upper limit, the operations conclude without changing the bit width.

Accordingly, when the error rate detected by the error detective unit 1804 is lower than the target error rate, the sampling frequency of the AD converting unit 1801 or the operating frequency of the demodulating unit 1803 is lowered, or the bit width of the digital signal after the AD conversion is reduced, so that power consumption can be lowered with maintaining communication quality.

Another example of wireless communication apparatuses (the publication of Japanese patent application Laid-open No. 2005-39651, Patent Document 2) discloses that a portable information terminal apparatus notifies a base station apparatus of its own basic performance beforehand. According to this conventional embodiment, transmission with the portable information terminal apparatus with superiority in basic performance can be performed with low transmission power, and more schedules can be assigned. Therefore, throughput in the entire system can be improved, transmission power at the base station can be lowered, and portable information terminal apparatuses corresponding to purposes of users can be provided.

However, according to the conventional technique in Patent Document 1, the power consumption of the receiver can be reduced, by varying a bit width for digital signal processing of the receiver in response to an error rate (that is, an error rate of a transmission path condition), but the power consumption of the transmitter for the digital signal processing cannot be reduced. Specifically, there is no unit for reflecting a condition of the transmission path in a bit width for a digital signal processing of the transmitter.

Moreover, according to the conventional technique in Patent Document 2, the transmitting power at the base station can be reduced and also throughput of the entire system can be improved by varying transmitting power or assignment of schedules depending on a basic performance of portable information terminal apparatuses, but the power consumption cannot be lowered by varying a bit width for quantization at the digital signal processing unit of the transmitter.

### SUMMARY OF THE INVENTION

An object of the present invention is to provide a wireless communication system, a wireless communication apparatus, a wireless communication method, and a signal processing program therefor which improve disadvantages of the above described conventional examples and can lower power consumption of a digital signal processing at a transmitter in response to a condition of a transmission path.

In order to solve the problems above, a wireless communication system according to the present invention comprises a digital signal processing unit in a transmitting section on a transmission side, and communication is performed by digital transmission or analog transmission to transmit a signal processed by the digital signal processing unit to a reception side through a line, wherein a bit width selecting unit is established with the digital signal processing unit to vary a bit width for signal processing at the digital signal processing unit in accordance with a condition of a transmission path of the line from the reception side.

Accordingly, in this present invention, the number of bits for digital signal processing can be varied in accordance with a transmission path condition of a line, and thereby power consumption of a transmitter can be lowered effectively while maintaining quality of transmission signals.

Here, the digital signal processing unit in the transmitting section on the transmission side may include a modulating unit and a digital/analog converting unit, and the signal processing is performed in each unit with a signal bit width which is variably set by the bit width selecting unit.

Accordingly, the number of bits for the modulating unit and the digital/analog converting unit can be varied in accordance with a transmission path condition of a line, which can achieve a wireless communication system capable of lowering power consumption with respect to a transmitter entirely.

Moreover, a transmission path condition measuring unit on the reception side, described above, may comprise a function of determining a condition of the transmission path of the line based on a signal-to-interference power ratio, and a power ratio signal bit width selecting unit is established with the digital signal processing unit for selecting a signal bit width for the digital signal processing unit in the transmitting section on the transmission side in response to a determined transmission path condition of the line based on the signal-to-interference power ratio.

Accordingly, the number of bits for the digital signal processing is controlled in response to the signal-to-interference power ratio with respect to transmission signals of the line, which can achieve a wireless communication system capable of lowering power consumption for a transmitter.

Further, the transmitting section on the transmission side may includes a modulation/demodulation mode selecting unit for selecting a modulation or a demodulation mode for the line in accordance with a condition of the transmission path of the line from the reception side, and a modulation/demodulation mode signal bit width selecting unit for selecting a signal bit width of the signal processing unit in the transmitting section on the transmission side in accordance with the modulation or demodulation mode selected by the modulation/demodulation mode selecting unit, both of which may be established with the digital signal processing unit.

Accordingly, the number of bits for the digital signal processing is controlled in response to a modulation or demodulation mode, which can achieve a wireless communication apparatus capable of lowering power consumption for a transmitter.

A wireless communication method according to the present invention is a method to specify a procedure of communication performed by digital transmission or analog transmission for transmitting a transmission signal which has been digital signal processed, and the method comprises digital signal processing step of performing a digital signal processing for the transmission signal in the transmitting section on the transmission side, a transmitting step of performing communication by digital transmission or analog transmission for transmitting the signal processed in the digital signal processing step through a line, a transmission path condition measuring step of measuring a transmission path condition of the line on the reception side,

a transmission path condition transmitting step of transmitting the transmission path condition measured in the transmission path condition measuring step to the transmission side using a reverse line, and a signal bit width selecting step of varying a signal bit width for processing in the digital signal processing step on the transmission side in response to a transmission path condition of the line notified in the transmission path condition transmitting step through the reverse line.

Here, the digital signal processing step in the transmitting section on the transmission side may include a modulating step of modulating a signal and a digital/analog converting step of converting the signal modulated in the modulation step into a digital/analog signal, and a signal processing in the modulation step and a digital/analog converting step may be performed with a signal bit width variably set in the signal bit width selecting step.

Accordingly, the number of bits for the modulating unit and the digital/analog converting unit are varied in response to a transmission path condition of the line, so that the power consumption on the transmission side can be lowered effectively.

Further, a condition of the transmission path may be determined based on a signal-to-interference power ratio with respect to a transmission signal of the line in the transmission path condition measuring step.

Accordingly, the number of bits is controlled at the digital signal processing in response to the signal-to-interference power ratio with respect to the transmission signal of the line, and thereby the power consumption on the transmission side can be lowered effectively.

Moreover, the transmitting section on the transmission side may include a modulation/demodulation mode selecting step of selecting a modulation/demodulation mode for the line in response to a condition of the transmission path of the line from the reception side, and in the signal bit width selecting step, a signal bit width for processing in the digital signal processing step may be varied in response to a modulation/demodulation mode selected in the modulation/demodulation mode selecting step.

Accordingly, the number of bits for the digital signal processing is controlled in response to the modulation/demodulation mode, and thereby the power consumption on the transmission side can be lowered effectively.

In order to achieve the above object, a signal processing program for wireless communication according to the present invention is that functions of each component are programmed, with specifying execution contents of the wireless communication system on the transmission side and on the reception side respectively, so as to cause a computer to execute them in order to achieve each object.

Therefore, according to the signal processing program for wireless communication, the wireless communication systems on the transmission side and on the reception side can perform almost identical level of signal processes individually and rapidly, and the number of bits can be processed to be increased or reduced at a prescribed digital signal processing. Accordingly, when the signal processing program is executed for a wireless communication system, an operation can be performed rapidly and power consumption of a transmitter can be lowered effectively in this wireless communication system.

As described above, according to the present invention, bit widths for signal processes at the digital signal processing are varied in response to a condition of the transmission path of the line, so that a wireless communication system, a wireless communication apparatus, a wireless communication method, and a signal processing program therefor can be provided which are capable of lowering the power consumption for the digital signal processing in response to a condition of a transmission path, especially on the transmission side.

### BRIEF DESCRIPTION OF THE DRAWINGS

FIG. 1 is a block diagram showing a transmission side according to a first embodiment of the present invention.

FIG. 2 is a block diagram showing a reception side according to the first embodiment of the present invention.

FIG. 3 is a flowchart showing operations in the embodiment illustrated in FIGS. 1 and 2.

FIG. 4 is an explanatory diagram showing specific examples of bit width selections in the embodiment illustrated in FIGS. 1 and 2.

FIG. 5 is an explanatory diagram showing other specific examples of bit width selections in the embodiment illustrated in FIGS. 1 and 2.

FIG. 6 is a block diagram showing a transmission side according to a second embodiment of the present invention.

FIG. 7 is a flowchart showing operations in the embodiment illustrated in FIG. 6.

FIG. 8 is an explanatory diagram showing bit width selections in the embodiment illustrated in FIG. 6.

FIG. 9 is a block diagram showing a transmission side in an embodiment (1) which is a specific example of the present invention.

FIG. 10 is a block diagram showing a reception side in the embodiment (2) which is the specific example of the present invention.

FIG. 11 is a flowchart showing operations in the embodiment (1) illustrated in FIGS. 9 and 10.

FIG. 12 is an explanatory diagram showing a configuration of a wireless frame in the embodiment (1) illustrated in FIGS. 9 and 10.

FIG. 13 is an explanatory diagram showing specific examples of bit width selections in the embodiment (1) illustrated in FIGS. 9 and 10.

FIG. 14 is an explanatory diagram showing other specific examples of bit width selections in the embodiment (1) illustrated in FIG. 9 and 10.

FIG. 15 is a block diagram showing a transmission side in an embodiment (2) which is a specific example of the present invention.

FIG. 16 is a block diagram showing a reception side in the embodiment (2) which is the specific example of the present invention.

FIG. 17 is a flowchart showing operations in the embodiment (2) illustrated in FIGS. 15 and 16.

FIG. 18 is an explanatory diagram showing specific examples of bit width selections in the embodiment (2) illustrated in FIGS. 15 and 16.

FIG. 19 is a block diagram showing a configuration of an example according to a conventional art.

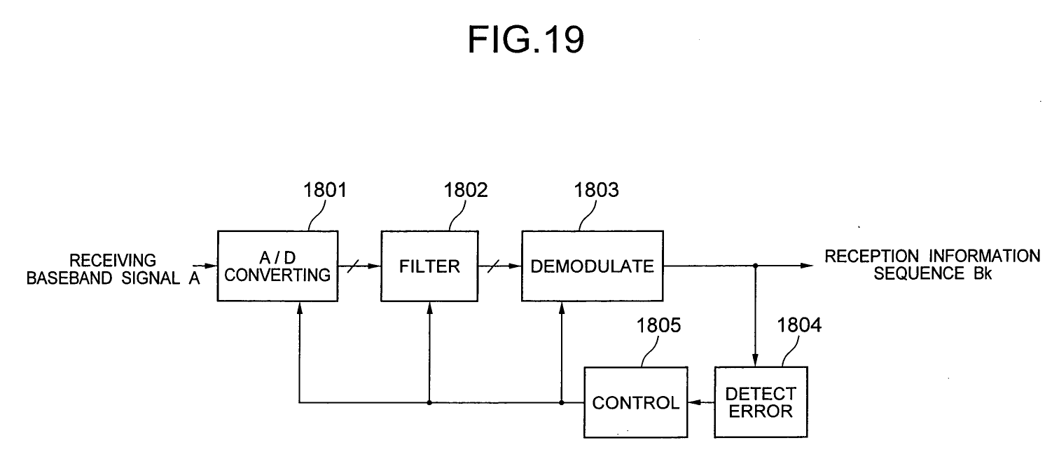

FIG. 20 is a flowchart showing operations in the example according to the conventional art illustrated in FIG. 19.

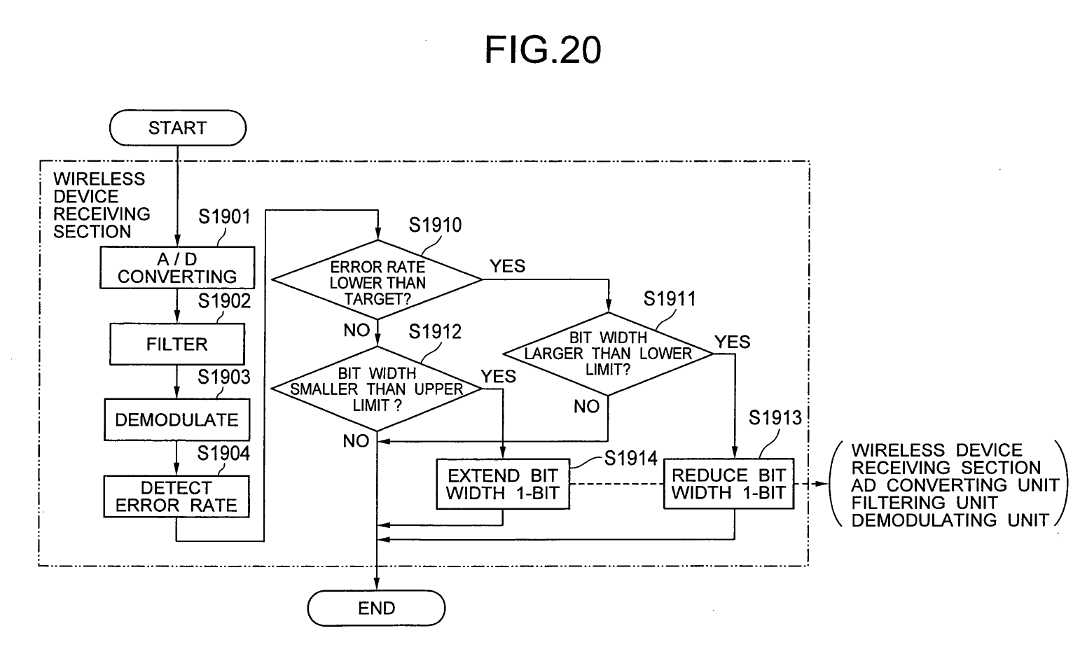

### DISCRIPTION OF THE PREFERRED EMBODIMENTS

### First Embodiment

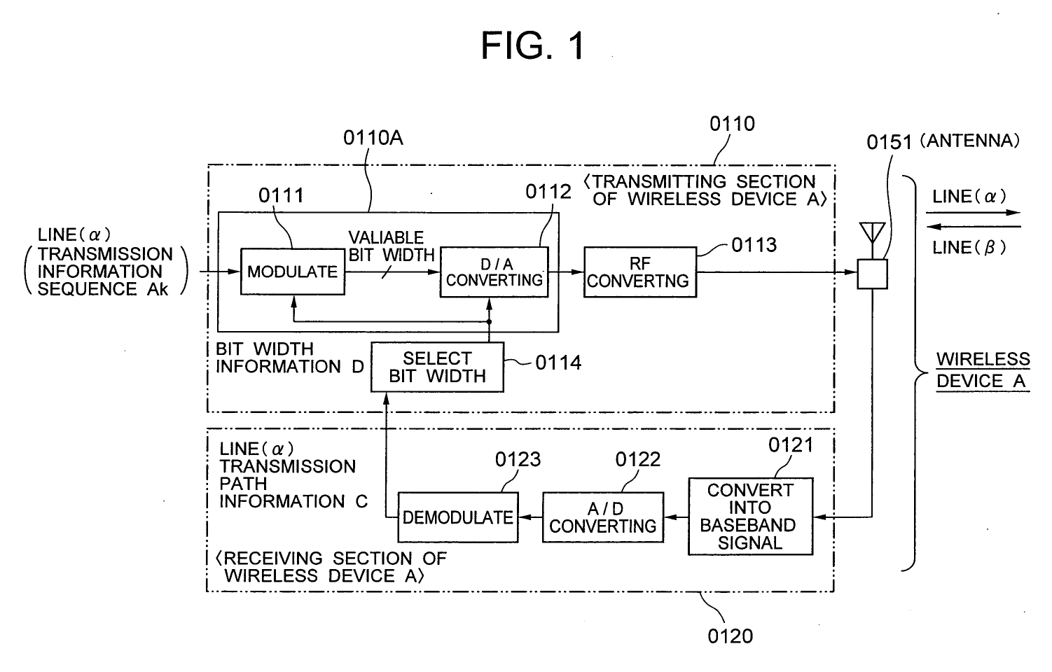

Next, a first embodiment of the present invention will be explained with reference to FIGS. 1 to 5.

First of all, a substantial part of the embodiment will be presented, and then an whole structure will be described.

### (Configuration)

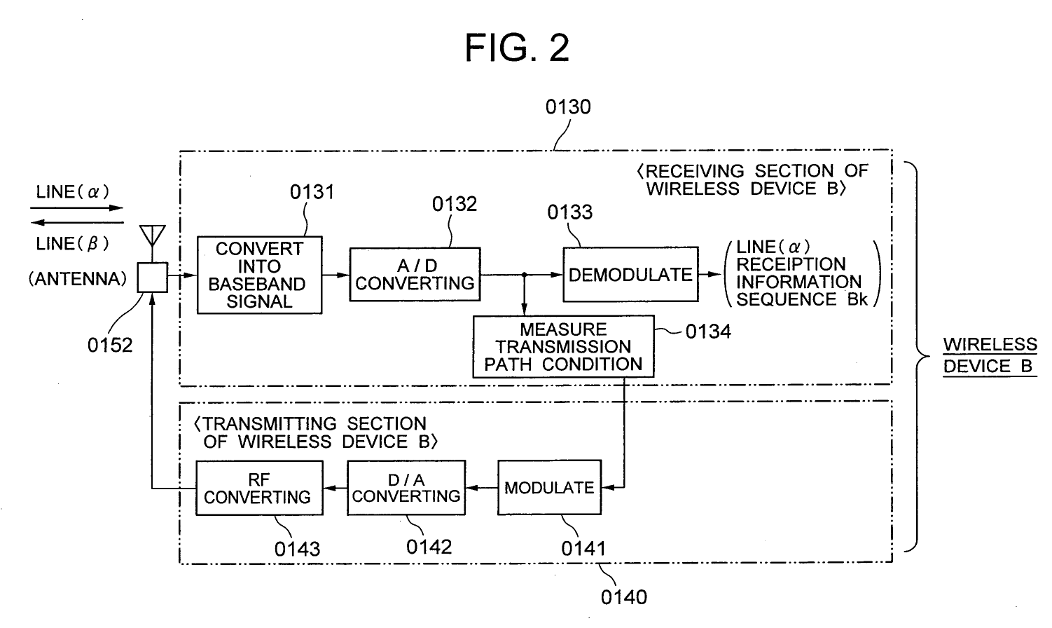

As shown in FIGS. 1 and 2, a line (α) and a line (β) are for transmission and reception in the present embodiment. A wireless device A on a transmission side as a wireless communication apparatus shown in FIG. 1 comprises a transmitting section 0110, a receiving section 0120, and an antenna unit 0151. A wireless device B on the reception side shown in FIG. 2 comprises a receiving section 0130, a transmitting section 0140, and an antenna unit 0152 of the wireless device B.

The transmitting section 0110 on the transmission side (the wireless device A) includes a digital signal processing unit 0110A, and has a function of performing communication by digital transmission or analog transmission of a signal processed by the digital signal processing unit 0110A to the reception side through the line (α).

Further, the reception side (the wireless device B) includes a transmission path condition measuring unit 0130 for measuring a transmission path condition of the line (α), a transmitting section 0140 on the reception side as a transmission path condition reversely transmitting unit for transmitting a condition of the transmission path of the line (α) measured by the transmission path condition measuring unit 0130 to the transmission side through a line (β) which is the reverse line with respect to the line (α).

Further, the transmission side (the wireless device A) includes a bit width selecting unit 0114 for varying a bit width for a signal processing at the digital signal processing unit 0110A in response to the transmission path condition (which means how good or bad) of the line (α) notified by the transmitting section (the transmission path condition reversely transmitting unit) 0140 on the reception side (the wireless device B) through the line (β).

Here, the digital signal processing unit 0110A in the transmitting section 0110 on the transmission side includes a modulating unit 0111 and a digital/analog converting unit 0112, in each of which a signal processing is performed with a signal bit width variably set at the bit width selection unit 0114.

Hereinafter, the above described example will be explained further.

The transmitting section 0110 of the wireless device A includes the modulating unit 0111, the DA (digital/analog) converting unit 0112, a RF (Radio Frequency) modulating unit 0113, and the bit width selecting unit 0114 in FIG. 1. Further, the receiving section 0120 of the wireless device A includes a baseband signal converting unit 0121, an AD (analog/digital) converting unit 0122, and a demodulating unit 0123.

Here, the modulating unit 0111 and the DA (digital/analog) converting unit 0112 configure the digital signal processing unit 0110A.

Moreover, the receiving section 0130 of the wireless device B includes a baseband signal converting unit 0131, an AD converting unit 0132, a demodulating unit 0133, and a transmission path condition measuring unit 0134. The transmitting section 0140 of the wireless device B includes a modulating unit 0141 and a DA converting unit 0142, and a RF converting unit 0143.

Each unit in the transmitting section 0110 of the wireless device A shown in FIG. 1 has following functions.

The modulating unit 0111 maps a transmission information sequence Ak provided as a transmitting signal into a signal space in which Ak is represented by amplitude or phase, and outputs it to the DA converting unit 0112 with a bit width according to bit width information D inputted from the bit width selecting unit 0114.

The DA converting unit 0112 converts a digital signal inputted from the modulating unit 0111 into an analog signal with the bit width according to the bit width information D inputted from the bit width selecting unit 0114, and outputs it to the RF converting unit 0113.

The RF converting unit 0113 up-converts the baseband signal inputted from the DA converting unit 0112 into a high-frequency signal, and outputs it to the antenna unit 0151.

The bit width selecting unit 0114 generates the bit width information D in response to line (α) transmission path information C inputted from the receiving section 0120 of the wireless device A, and outputs it to the modulating unit 0111 and the DA converting unit 0112 in the transmitting unit 0110 of the wireless device A.

The antenna unit 0151 amplifiers the radio frequency signal inputted from the RF converting unit 0113, and transmits it to the receiving unit 0130 of the wireless device B through the line (α).

The antenna unit 0152 shown in FIG. 2 receives and amplifiers the signal arrived from the transmitting section 0110 of the wireless device A through the line (α), and outputs it to the receiving unit 0130 of the wireless device B.

Each unit in the receiving section 0130 of the wireless device B shown in FIG. 2 has a operational function as follows.

The baseband signal converting unit 0131 down-converts the high-frequency signal inputted from the antenna unit 0152 into a baseband signal which is at a low-frequency, and outputs it to the AD converting unit 0132.

The AD converting unit 0132 samples and quantizes the analog signal inputted from the baseband signal converting unit 0131, and converts it into a digital signal, then outputs it to the demodulating unit 0133 and the transmission path condition measuring unit 0134.

The demodulating unit 0133 demodulates the digital signal inputted from the AD converting unit 0132, and obtains a line (α) reception information sequence Bk. The transmission path condition measuring unit 0134 measures a transmission path condition of line (α) by using the digital signal inputted from the AD converting unit 0132, and outputs the measured result to the transmitting section 0140 of the wireless device B.

Moreover, each unit of the transmitting section 0140 of the wireless device B includes an operational function as follows.

The modulating unit 0141 has a function of mapping a line (α) transmission path condition inputted from the receiving section 0130 of the wireless device B into a signal space in which the condition is represented by amplitude or phase, and outputs it to the DA converting unit 0142.

The DA converting unit 0142 converts the digital signal inputted from the modulating unit 0141 into an analog signal, then outputs it to the RF converting unit 0143. The RF converting unit 0143 up-converts the baseband signal inputted from the DA converting unit 0142 into a high-frequency signal, then outputs it to the antenna unit 0152.

The antenna unit 0152 amplifies the radio frequency signal inputted from the RF converting unit 0143, and transmits it to the receiving section 0120 of the wireless device A through the line (β).

The antenna unit 0151 shown in FIG. 1 receives and amplifiers the signal arrived from the transmitting section 0140 of the wireless device B through the line (β), and outputs it to the receiving unit 0120 of the wireless device A.

Each unit in the receiving section 0120 of the wireless device A shown in FIG. 1 has an operational function as follows.

The baseband signal converting unit 0121 down-converts the high-frequency radio signal inputted from the antenna unit 0151 into a baseband signal at low-frequency, then outputs it to the AD converting unit 0122. The AD converting unit 0122 samples and quantizes the analog signal inputted from the baseband signal converting unit 0121, and converts it to a digital signal, then outputs it to the demodulating unit 0123.

The demodulating unit 0123 obtains the line (α) transmission path information C demodulating the digital signal inputted from the AD converting unit 0122, and outputs it to the bit width selecting unit 0114 in the transmitting section 0110 of the wireless device A.

### (Overall Operation)

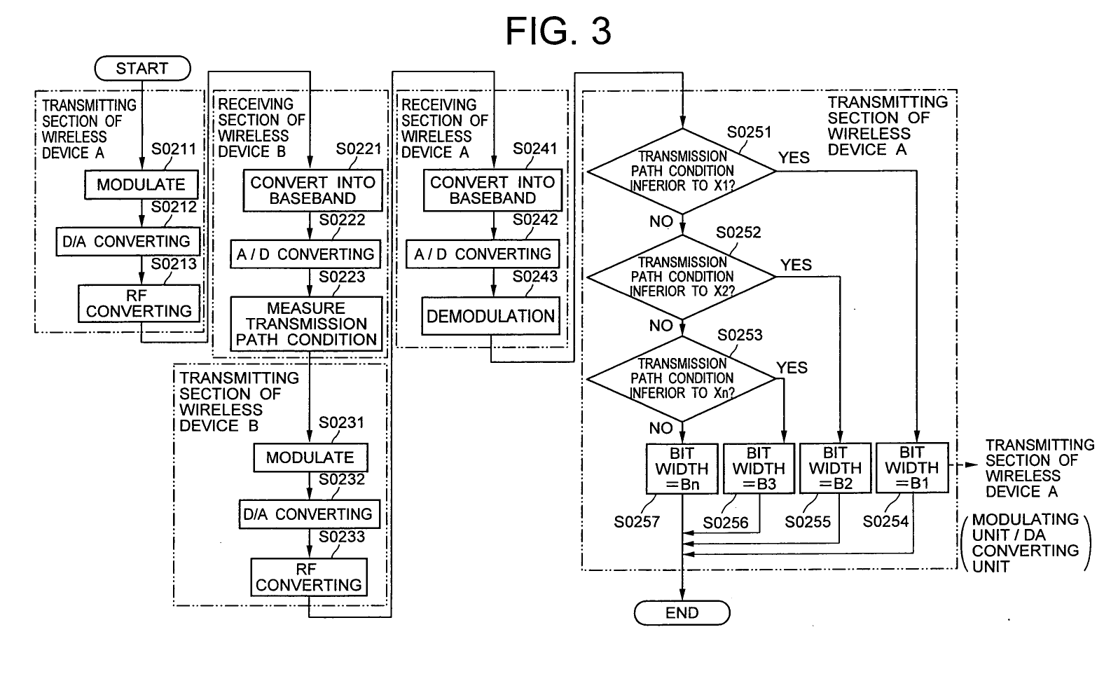

Next, the overall operation of the first embodiment will be explained in detail with reference to the flowchart in FIG. 3.

The flowchart shown in FIG. 3 illustrates a successive operation in which a transmission path condition of the line (α) transmitted from the transmitting section 0110 of the wireless device A is measured in the receiving unit 0130 of the wireless device B, and the measured condition of the transmission path is transmitted from the transmitting section 0140 of the wireless device B through the line (β) and received by the receiving section 0120 of the wireless device A as the line (α) transmission path information C, then a bit width is varied in response to the transmission path condition of the line (α) in the transmitting section 0110 of the wireless device A.

Firstly, the modulating unit 0111 in the transmitting section 0110 of the wireless device A modulates the transmission sequence Ak provided as a transmitting signal (Step S0211: a modulating step). The DA converting unit 0112 converts the modulated digital signal into an analog signal (Step S0212: a digital/analog converting step, a digital signal processing step).

The RF converting unit 0113 up-converts the analog signal, which has been converted in the DA converting unit 0112, into a radio frequency so as to transmit (Step S0213: a transmitting step).

Here, the digital signal processing step including the modulating step and the digital/analog converting step, as mentioned above, and the transmitting step may be functionalized so as to be executed on a computer.

Next, the radio frequency signal transmitted from the transmitting section 0110 of the wireless device A is down-converted into a baseband signal at the baseband signal converting unit 0131 in the receiving section of the wireless device B (Step S0221).

The AD converting unit 0132 converts the analog signal, which has been converted into the baseband signal at the baseband signal converting unit 0131, into a digital signal (Step S0222).

The transmission path condition measuring unit 0134 measures a transmission path condition of the line (α) based on the AD converted digital signal with reference to a pilot channel and the like which is known information for the wireless device A and the wireless device B (Step S0223: a transmission path condition measuring step).

The modulating unit 0141 in the transmitting section 0140 of the wireless device B modulates information about the transmission path condition of the line (α) measured at the transmission path condition measuring unit 0134 (Step S0231). The DA converting unit 0142 converts the digital signal about the modulated information on the transmission path condition of the line (α) into an analog signal (Step S0232). The RF converting unit 0143 up-converts the DA converted analog signal into a radio frequency, and transmits it (Step S0233: a transmission path condition transmitting step).

Here, the transmission path condition measuring step and the transmission path condition transmitting step may be functionalized so as to be executed on a computer.

The radio frequency signal transmitted from the transmitting section of the wireless device B is down-converted by the baseband signal converting unit 0121 in the receiving section 0120 of the wireless device A into a baseband signal (Step S0241). The AD converting unit 0122 converts the analog signal which has been converted into the baseband signal at the baseband signal converting unit 0121 into a digital signal (Step S0242).

The demodulating unit 0123 demodulates the digital signal converted at the AD conversion unit 0122, and obtains the line (α) transmission path information C (Step S0243). The bit width selecting unit 0114 in the transmitting section of the wireless device A selects a bit width for the modulating unit and the DA converting unit in the transmitting section of the wireless device A in response to the line (α) transmission path information C.

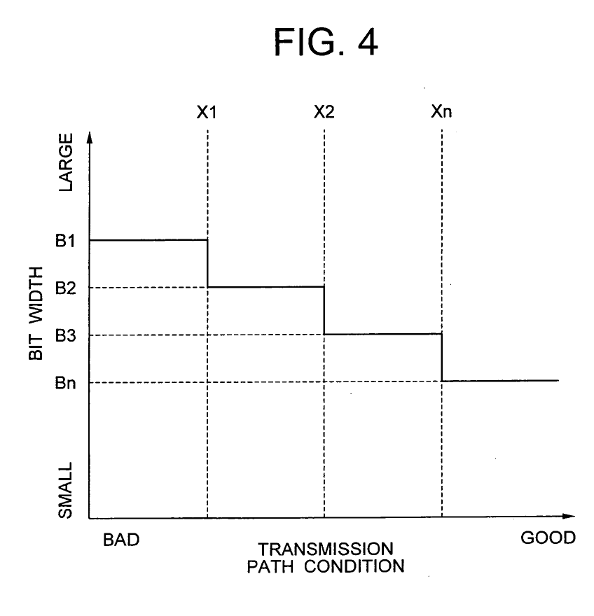

Here, an operation for selecting a bit width will be explained specifically with reference to the flowchart in FIG. 3 and the illustration diagram for the bit selection depending on the transmission path condition in FIG. 4.

Firstly, when the transmission path condition is inferior to X1 in Step S0251 of FIG. 3, the processing proceeds to the Step S0254, in which the bit width becomes B1. When it is not inferior to X1, the processing proceeds to the next determining step S0252. In Step S0252, when the transmission path condition is inferior to X2 but it is not inferior to X1, the processing proceeds to the Step 0255, in which the bit width becomes B2. When it is not inferior to X2, the processing proceeds to the next determining step S0253.

In Step S0253, when the transmission path condition is inferior to Xn but it is not inferior to X1 and X2, the processing proceeds to Step S0256, in which the bit width becomes B3. When it is not inferior to Xn, the processing proceeds to Step S0257, in which the bit width becomes Bn.

As described above, the selected bit width is notified to the modulating unit 0111 and the DA converting unit 0112 in the transmitting section 0110 of the wireless device A, then the modulating unit 0111 and the DA converting unit 0112 perform the digital signal processing in accordance with the notified bit width (a signal bit width selecting step).

Here, the signal bit width selection step described above may be functionalized so as to be executed on a computer.

As shown in FIG. 4, when a transmission path of the line (α) is in good condition, the bit width for the digital signal processing in the transmitting section 0110 of the wireless device A is reduced as B1→B2→B3→Bn. When the transmission path of the line (α) is in bad condition, the bit width is increased inversely. Accordingly, power consumption of a digital signal processing circuit can be lowered while maintaining communication quality in the case of the wireless communication system which requires a certain level of communication quality for throughput and the like.

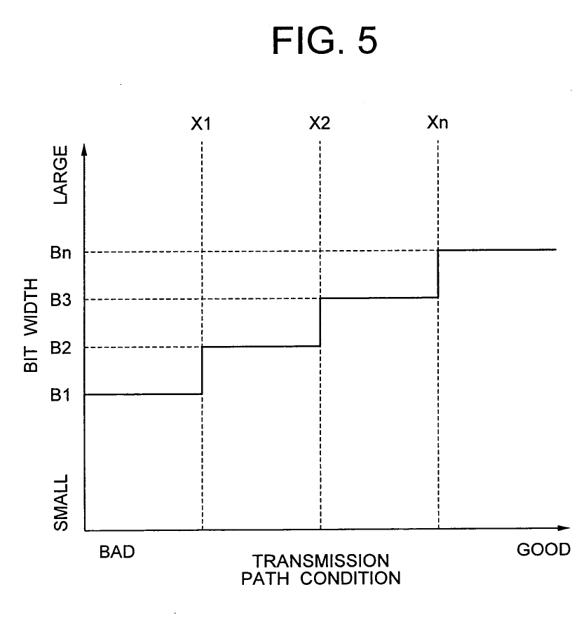

The first embodiment has been presented hereinbefore in order to put the present invention into practice, in addition, this present invention is also applicable to another bit width control method in which the relationship between the transmission path condition and the bit width is opposite to the one in the embodiment shown in FIG. 4. That is, in the case of a wireless communication system in which transmission capacity is increased intensively when the transmission is in good condition, as shown in FIG. 5, the bit width is extended when a transmission path is in good condition, while the bit width is reduced in bad condition, so that the power consumption can be lowered in the digital signal processing.

### Second Embodiment

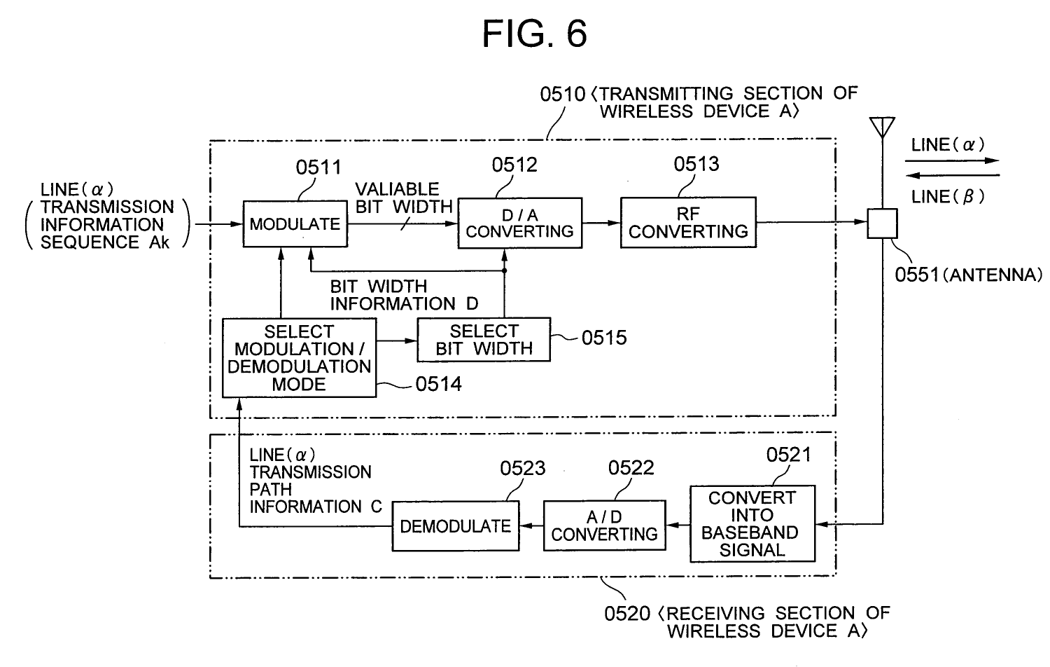

Next, a second embodiment according to the present invention will be explained with reference to FIGS. 6 to 8.

Here, the same numerals are used for the same components as in the first embodiment mentioned above.

FIG. 6 is a block diagram showing the second embodiment illustrating the wireless device A on the transmission side. For the wireless device B on the reception side, the same drawing as in FIG. 2, mentioned above, is used.

The second embodiment, as shown in FIG. 6, is an example applied the adaptive modulation/demodulation control in which a modulation/demodulation mode for the line (α) is varied in response to a transmission path condition after transmission/reception through the lines (α) and (β).

In FIG. 6, a transmission side (the wireless device A) comprises a transmitting section 0510 of the wireless device A, a receiving section 0520 of the wireless device A, and an antenna unit 0551.

The transmitting section 0510 of the wireless device A includes a modulating unit 0511, the DA converting unit 0512, the RF converting unit 0513, the modulation/demodulation mode selecting unit 0514, and a bit width selecting unit 0515. The receiving section 0512 of the wireless device A includes a baseband signal converting unit 0521, the AD converting unit 0522, and a demodulating unit 0523.

In addition, there is another unit, which is not illustrated in FIG. 6, for notifying the receiving section 0130 of the wireless device B of a selected modulation/demodulation mode in order to perform the adaptive modulation/demodulation control.

The transmitting section 0510 of the wireless device A has operational functions shown as follows.

The modulating unit maps a transmission information sequence Ak into a signal space in which the information sequence is represented by amplitude or phase in accordance with a modulation/demodulation mode inputted from the modulation/demodulation mode selecting unit 0514, then outputs it to the DA converting unit 0512 with a bit width according to bit width information D inputted from the bit width selecting unit 0515.

The DA converting unit 0512 converts the digital signal inputted from the modulating unit 0511 into an analog signal with the bit width according to the bit width information D inputted from the bit width selecting unit 0515, then outputs it to the RF converting unit 0513.

The RF converting unit 0513 up-converts the baseband signal inputted from the DA converting unit 0512 into a high frequency radio signal, then outputs it to the antenna unit 0551. The modulation/demodulation selecting unit 0514 selects a modulation/demodulation mode for the line (α) in accordance with line (α) transmission path information C inputted from the receiving section 0520 of the wireless device A, then outputs the selected modulation/demodulation mode to the modulating unit 0511 and the bit width selecting unit 0515.

The bit width selecting unit 0515 generates the bit width information D in response to the line (α) modulation/demodulation mode inputted from the modulation/demodulation mode selecting unit 0514, then outputs it to the modulating unit 0511 and the DA conversion unit 0512 in the transmitting section 0510 of the wireless device A.

Here, operational functions of each unit in the transmitting section 0510 of the wireless device A may be programmed to be executed on a computer.

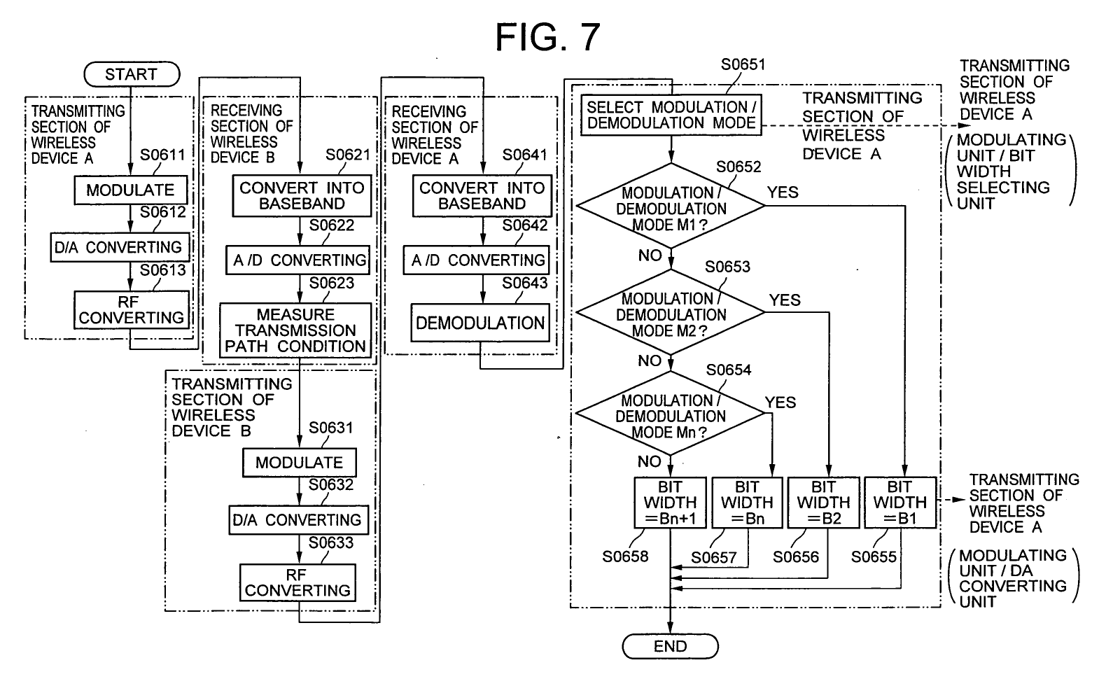

FIG. 7 is a flowchart showing an operation according to the embodiment with the wireless device A shown in FIG. 6 and the wireless device B shown in FIG. 2. The operation is that a transmission path condition of the line (α) from the transmitting section 0510 of the wireless device A is measured in the receiving section 0130 of the wireless device B, and the measured transmission path condition of the line (α) is transmitted from the transmitting section 0140 of the wireless device B through the line (β) and received by the receiving section 0520 of the wireless device A, then a bit width is varied in response to a modulation/demodulation mode for the line (α) selected in the transmitting section 0510 of the wireless device A.

Next, a specific operational procedure according to the second embodiment will be explained in detail with reference to the flowchart in FIG. 7.

Firstly, the modulating unit 0511 in the transmitting section 0510 of the wireless device A modulates a transmission sequence Ak in Step S0611. The DA converting unit 0512 D-A converts the modulated digital signal into an analog signal in Step S0611 (a digital signal processing step).

The RF converting unit 0513 up-converts the signal converted into an analog signal at the DA converting unit 0512 into a radio frequency in Step S0613, then transmits it (a transmitting step).

Here, the digital signal processing step and the transmitting step described above may be functionalized so as to be executed on a computer.

On the other hand, a baseband signal converting unit 0131 in the receiving section 0130 of the wireless device B converts the radio frequency signal received through the line (α) into a baseband signal in Step S0621.

An AD converting unit 0132 on the reception side converts the analog signal which has been converted into a baseband signal at the baseband signal converting unit 0131 into a digital signal in Step S0622. A transmission path condition measuring unit 0134, which is also on the reception side, measures the transmission path condition of the line (α) based on the AD converted digital signal with reference to a pilot channel and the like which is known information between the wireless devices A and B in Step S0623 (a transmission path condition measuring step).

A modulating unit 0141 in the transmitting section 0140 of the wireless device B modulates information C about the transmission path condition of the line (α) which has been measured at the transmission path condition measuring unit 0134 in Step S0631.

A DA converting unit converts the digital signal of the modulated information C on the transmission path condition of the line (α) into an analog signal in Step S0632. A RF converting unit 0143 up-converts the D-A converted analog signal into a radio frequency signal, and transmits it in Step S0633 (a transmission path condition transmitting step).

Here, the transmission path condition measuring step and the transmission path condition transmitting step mentioned above may be functionalized so as to be executed on a computer.

Next, a baseband signal converting unit 0521 in the receiving section 0520 of the wireless device A down-converts the radio frequency signal transmitted from the transmitting section 0140 of the wireless device B into a baseband signal in Step S0641.

An AD conversion unit 0522 converts the analog signal which has been converted into a baseband signal at the baseband signal converting unit 0521 into a digital signal in Step S0642.

A demodulating unit 0523 demodulates the signal which has been converted into a digital signal at the AD converting unit 0522 in Step S0643, then obtains the transmission path information C of the line (α).

The modulation/demodulation mode selecting unit 0514 in the transmitting section 0510 of the wireless device A selects a modulation/demodulation mode for the line (α) in response to the transmission path condition in Step S0651. The selected modulation/demodulation mode is notified to the modulating unit 0511 and the signal bit width selecting unit 0515. The signal bit width selecting unit 0515 selects a bit width for the modulating unit 0511 and the DA converting unit 0512 in the transmitting section of the wireless device A corresponding to the modulation/demodulation mode.

Here, the operational functions included in the modulation/demodulation mode selecting unit 0514 and the signal bit width selecting unit 0515 mentioned above may be programmed so as to be executed on a computer.

Next, the bit width selecting operation after the modulation/demodulation is selected will be explained specifically with reference to FIG. 7.

When the modulation/demodulation mode is M1 in the determining step S0652, the processing proceeds to the Step S0655, in which the bit width becomes B1. When it is not M1, the processing proceeds to the following determination Step S0653.

When the modulation/demodulation mode is not M1 but M2 in the determination step S0653, the processing proceeds to the Step S0656, in which the bit width becomes B2. When it is not M2, the processing proceeds to the determination Step S0654.

When the modulation/demodulation mode is not M1 nor M2 in the determination step S0654, but Mn, the processing proceeds to the Step 0657 in which the bit width becomes Bn. When it is not Mn, the processing proceeds to the Step S0658, in which the bit width becomes B(n+1).

The selected bit width is notified to the modulating unit 0511 and the DA converting unit 0512 in the transmitting section 0510 of the wireless device A, and then the modulating unit 0511 and the DA converting unit 0512 perform the digital signal processing in accordance with the notified bit width.

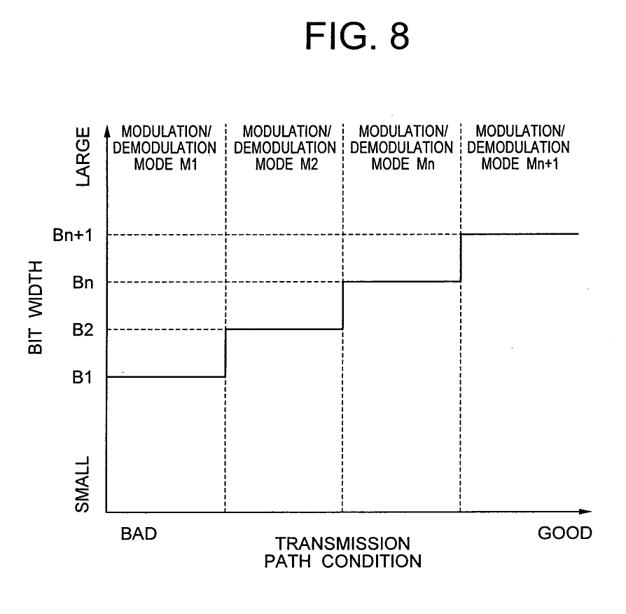

As shown in FIG. 8, the modulation/demodulation mode and the bit width are responded to each other so as to extend the bit width for the digital signal processing in the transmitting section 0510 with respect to the line (α) when the modulation multiple value number of the modulation/demodulation mode for the line (α) is large, and to reduce the bit width when the modulation multiple value number of the modulation/demodulation mode for the line (α) is small. Namely, when the transmission path is in good condition and the modulation/demodulation mode with the large number of modulation multiple value are selected, and if the modulation/demodulation mode is 16 QAM (16 Quadrature Amplitude Modulation) for example, a bit width is to be extended because the modulation is required to be highly accurate due to increasing a symbol pattern by 1-bit per orthogonal component comparing with the case of QPSK (Quadrature Phase Shift Keying).

When the transmission path is in bad condition and a modulation/demodulation mode with a small number of the modulation multiple value is selected, modulation is not required to be highly accurate, so that a bit width is reduced. Accordingly, when the bit width to use is variable in response to a modulation/demodulation mode, the power consumption of the transmitting section 0510 can be lowered.

The first and the second embodiments described above have structures in which the bit widths are variable for the modulating units 0111, 0511, and the DA converting units 0112, 0512. Further, other signal processing units may be connected to the structures. The wider the applicable range of a signal processing unit with variable bit width is, the more effective it is to lower power consumption.

A signal processing unit can be added or removed to/from the transmitting sections 0110, 0510 of the wireless device A, the receiving sections 0120, 0520 of the wireless device A, the receiving section 0130 of the wireless device B, and the transmitting section 0140 of the wireless device B in response to a wireless communication system of the lines (α) and (β), and the number of the signal processing units is not limited. The number of the variable patterns for bit width is presented as four in the above explanation, however, the number of variable patterns for bit width is not limited.

### Embodiment (1)

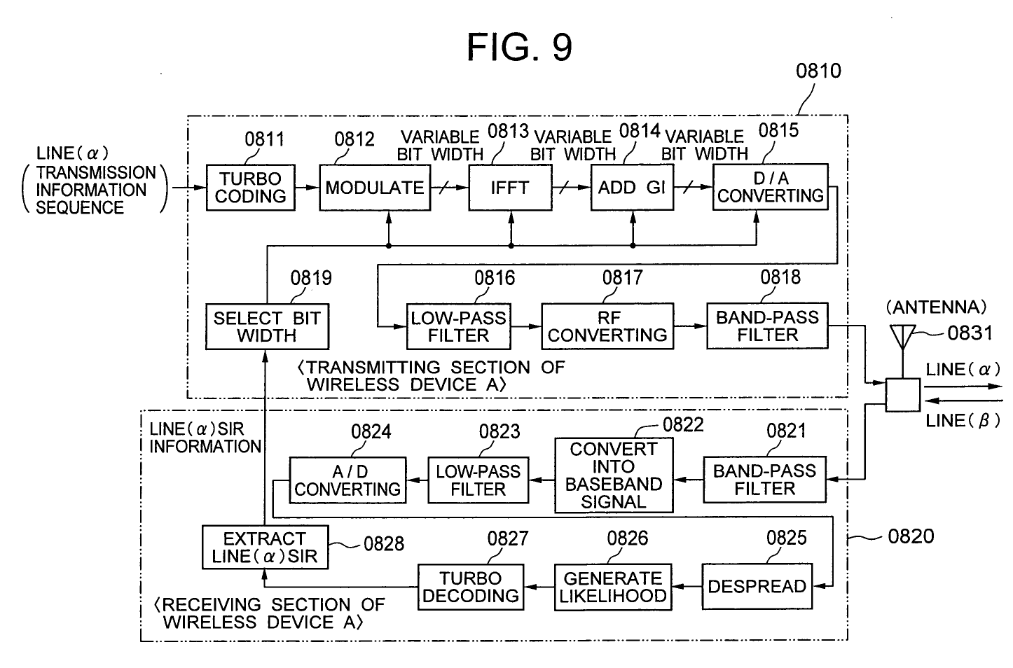

Next, a specific example according to the present invention will be explained in further detail as an embodiment (1) with reference to FIGS. 9 to 14.

This embodiment (1) uses the lines (α) and (β) for transmission/reception, and adapts OFDM (Orthogonal Frequency Division Multiplex) system in which a plurality of carrier waves are arranged without interfering with each other on the line (α).

As shown in FIG. 9, a signal transmitting side of the present embodiment (1) comprises a transmitting section 0810 of a wireless device A for performing a transmitting processing for the line (α), a receiving section 0820 of the wireless device A for performing a receiving processing for the line (β), and an antenna unit 0831.

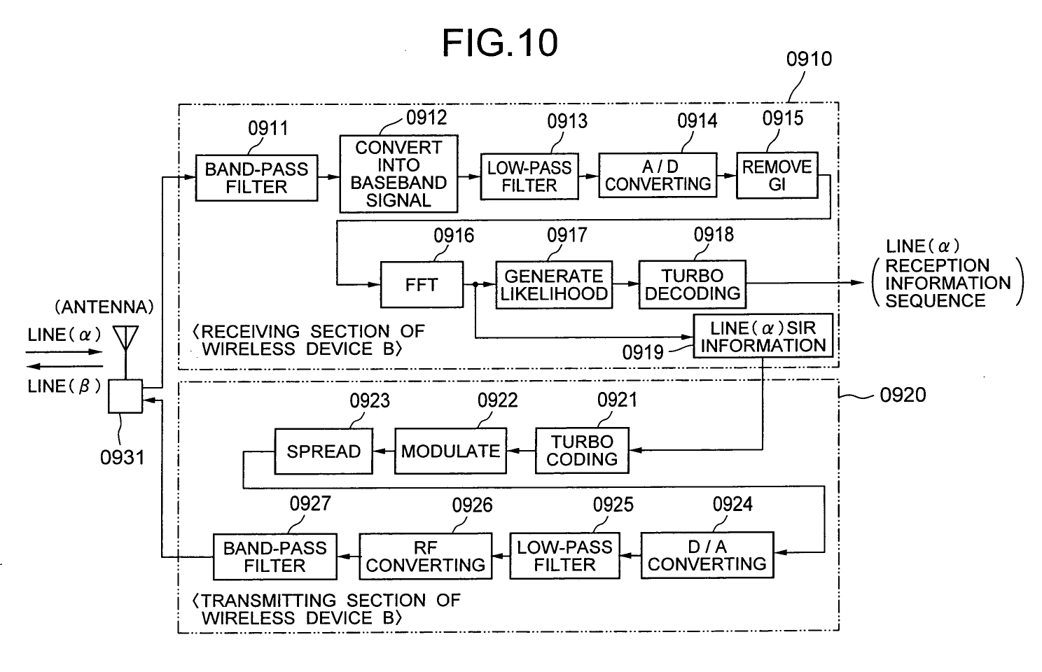

Further, as shown in FIG. 10, a signal reception side of the present embodiment (1) comprises a receiving section 0910 of a wireless device B for performing a receiving processing for the line (α), a transmitting section 0920 of the wireless device B for performing a transmitting processing for the line (β), and an antenna unit 0931.

Here, the transmitting section 0810 of the wireless device A will be explained in detail with reference to a block diagram for the wireless device A in FIG. 9.

The transmitting section 0810 of the wireless device A comprises a turbo coding unit 0811 for achieving an error correcting function based on a block code as an error-correction coding unit, a modulating unit 0812 for performing digital modulation such as QPSK (Quadurature Phase Shift Keying), 16 QAM (Quadrature Amplitude Modulation), or 64 QAM, an IFFT (Inverse Fast Fourier Transform) unit 0813 for performing inverse Fourier transform, a GI (Guard Interval) adding unit 0814 for featuring multipath durability, and a DA (digital/analog) converting unit 0815.

The transmitting section 0810 of the wireless device A further comprises a low-pass filtering unit 0816 for removing a high-frequency component along with digital modulation, a RF (Radio Frequency) converting unit 0817 for converting a baseband signal at a low frequency into a high frequency signal, a band-pass filtering unit 0818 for passing frequencies within a desired band range, a bit width selecting unit 0819 for selecting a signal bit width for each block of the modulating unit 0812, the IFFT unit 0813, the GI adding unit 0814, and the DA converting unit 0815 of the transmitting section 0810 of the wireless device A depending on information about a signal-to-interference power ratio (hereinafter, “SIR”) with respect to a desired signal on the line (α) inputted from the receiving section 0820 of the wireless device A.

Next, the receiving section 0820 of the wireless device A in the present embodiment (1) will be explained with reference to FIG. 9.

In the embodiment (1), the receiving section 0820 of the wireless device A comprises a band-pass filtering unit 0821, a baseband signal converting unit 0822, a low-pass filtering unit 0823, an AD converting unit 0824, a despreading unit 0825, a likelihood generating unit 0826 for calculating a likelihood of a receiving signal, a turbo decoding unit 0827, and a line (α) SIR extracting unit 0828 for taking out an SIR of the line (α) from the decoded bit stream.

Next, the receiving unit 0910 of the wireless device B will be explained with reference to a block diagram for the wireless device B in FIG. 10.

In the embodiment (1), the receiving section 0910 of the wireless device B comprises a band-pass filtering unit 0911, a baseband signal converting unit 0912, a low-pass filtering unit 0913, an AD converting unit 0914, a GI removing unit 0915, a FFT (Fast Fourier Transform) unit 0916, a likelihood generating unit 0917, a turbo decoding unit 0918, and a line (α) SIR measuring unit 0919 for measuring a signal-to-interference power ratio of the line (α) as a transmission path condition of the line (α).

Further, the transmitting section 0920 of the wireless device B will be explained with reference to FIG. 10.

In the embodiment (1), the transmitting section 0920 of the wireless device B comprises a turbo coding unit 0921, a modulating unit 0922, a spreading unit 0923, a DA converting unit 0924, a low-pass filtering unit 0925, a RF converting unit 0926, and a band-pass filtering unit 0927.

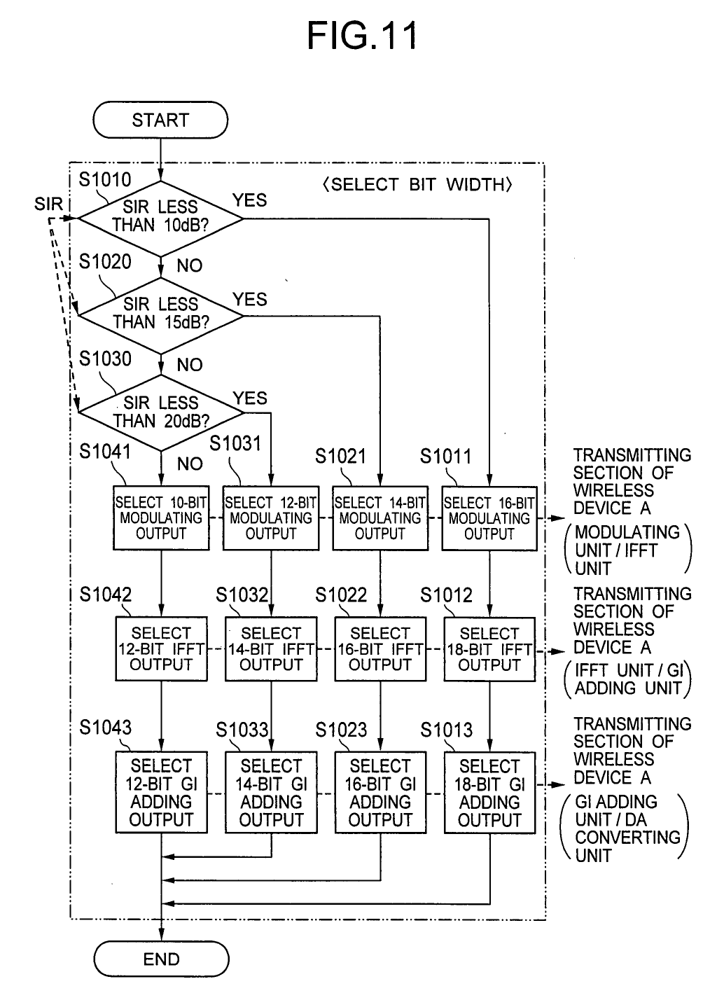

Next, an operation for selecting bit widths in the transmitting section 0810 of the wireless device A with reference to a flowchart in FIG. 11.

A determining step S1010 is performed in the bit width selecting unit 0819 of the wireless device A referring to a SIR of the line (α) notified by the receiving section 0910 of the wireless device B, where it is determined if the SIR is less than 10 [dB]. When the SIR is less, a modulating output bit selecting unit step S1011 is performed. If the SIR is not less, the following determining step, S1020 is performed.

When the SIR is less than 10 [dB] in the determining step S1010, a bit width for the modulating unit 0812 after digital modulation is set in 16-bit in the modulating output bit selecting unit step S1011, and the selected bit width is outputted to the modulating unit 0812 and the IFFT unit 0813 in the transmitting section 0810 of the wireless device A.

Next, a IFFT output bit selecting unit step S1012 is performed, where a bit width for the IFFT unit 0813 is set in 18-bit, and the selected bit width is outputted to the IFFT unit 0813 and the GI adding unit 0814 in the transmitting section 0810 of the wireless device A.

Moreover, a GI adding output bit selecting unit step S1013 is performed, where an output bit width for the GI adding unit 0814 is set in 18-bit, and the bit width is outputted to the GI adding unit 0814 and the DA converting unit 0815 in the transmitting section 0818 of the wireless device A.

When the SIR is not less than 10 [dB] in Step S1010, it is determined in a determining step S1020 if the SIR is less than 15 [dB]. When the SIR is less, a modulation output bit width selecting unit step S1021 is performed. When the SIR is not less, a next determining step S1030 is performed.

When the SIR is less than 15 [dB] in the determining step S1020, the bit width for the modulating unit 0812 after digital modulation is set in 14-bit in the modulating output bit selecting unit step S1021, and the selected bit width is outputted to the modulating unit 0812 and the IFFT unit 0813 in the transmitting section 0810 of the wireless device A.

Next, an IFFT output bit selecting unit step S1022 is performed, where an output bit width for the IFFT unit 0813 is set in 16-bit, and the bit width is outputted to the IFFT unit 0813 and the GI adding unit 0814 in the transmitting section 0810 of the wireless device A.

Further, a GI adding output bit selecting unit step S1023 is performed, where an output bit width for the GI adding unit 0814 is set in 16-bit, and the bit width is outputted to the GI adding unit 0814 and the DA converting unit 0815 in the transmitting section 0810 of the wireless device A.

When the SIR is not less than 15 [dB] in the determining step S1020, the following step is Step S1030, and it is determined if the SIR is less than 20 [dB]. When the SIR is less, a modulation output bit width selecting unit step S1031 is performed. When it is not less, a modulation output bit width selecting unit step S1041 is performed.

When the SIR is less than 20 [dB] in a determining step S1030, a bit width for the modulating unit 0812 after digital modulation is set in 12-bit in a modulating output bit selecting unit step S1031, and the selected bit width is outputted to the modulating unit 0812 and the IFFT unit 0813 in the transmitting unit 0810 of the wireless device A.

Next, an IFFT output bit selecting unit step S1032 is performed, where an output bit width for the IFFT unit 0813 is set in 14-bit, and outputs it to the IFFT unit 0813 and the GI adding unit 0814 in the transmitting section 0810 of the wireless device A.

Further, a GI adding output bit selecting unit Step S1033 is performed, where an output bit width is set in 14-bit for the GI adding unit 0814, and outputs it to the GI adding unit 0814 and the DA converting unit 0815 in the transmitting section 0810 of the wireless device A.

When the SIR is not less than 20 [dB] in a determining step S1030, a bit width for the modulating unit 0812 after digital modulation is set in 10-bit in a modulating output bit selecting unit step S1041, and the selected bit width is outputted to the modulating unit 0812 and the IFFT unit 0813 in the transmitting section 0810 of the wireless device A.

Next, an IFFT output bit selecting unit step S1042 is performed, where an output bit width is set in 12-bit for the IFFT unit 0813, and outputs it to the IFFT unit 0813 and the GI adding unit 0814 in the transmitting section 0810 of the wireless device A.

Further, a GI adding output bit selecting unit step S1043 is performed, where an output bit width is set in 12-bit for the GI adding unit 0814, and outputs it to the GI adding unit 0814 and the DA converting unit 0815 in the transmitting section 0810 of the wireless device A.

The modulating unit 0812, the IFFT unit 0813, the GI adding unit 0814, and the DA converting unit 0815 in the transmitting section 0810 of the wireless device A input a signal, process the signal, and output a processing result in accordance with each input/output bit width inputted from the bit width selecting unit 0819 in the transmitting section 0810 of the wireless device A.

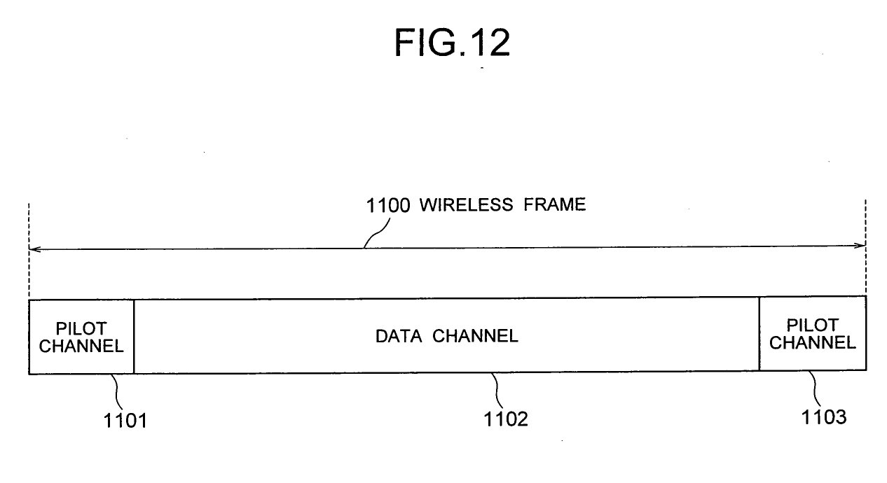

The selected bit width is reflected to a bit width at a digital signal processing unit in the transmitting section 0810 of the wireless device A with each wireless frame or each of plurality of wireless frames. When a wireless frame to be transmitted comprises a pilot channels 1101, 1103 and a data channel 1102, as shown in FIG. 12, and when an SIR can be measured on the reception side using the pilot channel, it is preferable that a bit width for processing the pilot channel is fixed, and a bit width for processing a data channel is variable.

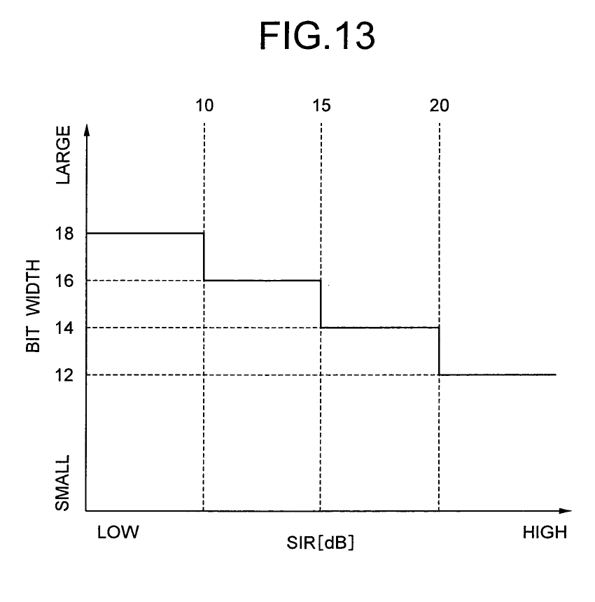

For example, controlling a bit width for an IFFT output is shown in FIG. 13.

In order to reduce power consumption for IFFT of the line (α), a calculating output bit width is reduced when a SIR is high, while the calculating output bit width is extended when the SIR is low. Because IFFT requires a large amount of calculation especially, reducing bit width is significantly effective in reducing power consumption. Accordingly, the number of bits for calculating output is reduced when the transmission path is in good condition, while the number of bits is increased when the transmission path is in bad condition, so that power consumption of a digital signal processing circuit can be lowered while maintaining communication quality of throughput and the like.

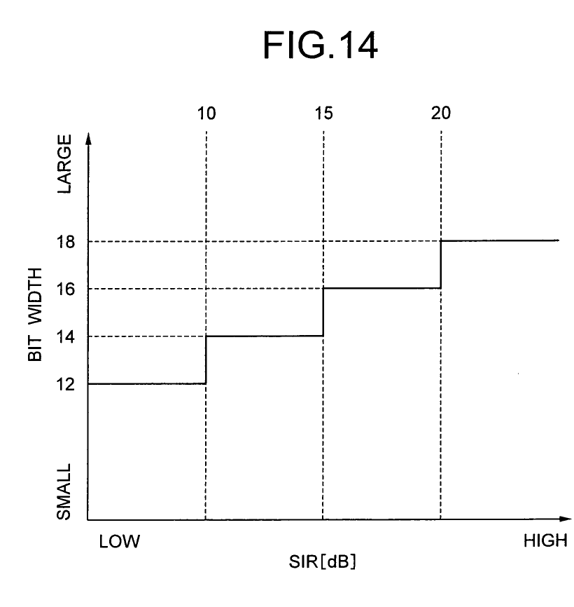

In the embodiment (1) described above, the operational example has been explained where a bit width is reduced when the transmission path is in good condition, while a bit width is extended when the transmission path is in bad condition. However, in the case of a wireless communication system in which transmission capacity is increased intensively when the transmission path is in good condition, an operation can be applied where a bit width for IFFT is extended when the transmission path is in good condition, for example, while a bit width for IFFT is reduced when the transmission path is in bad condition, as shown in FIG. 14.

### Embodiment (2)

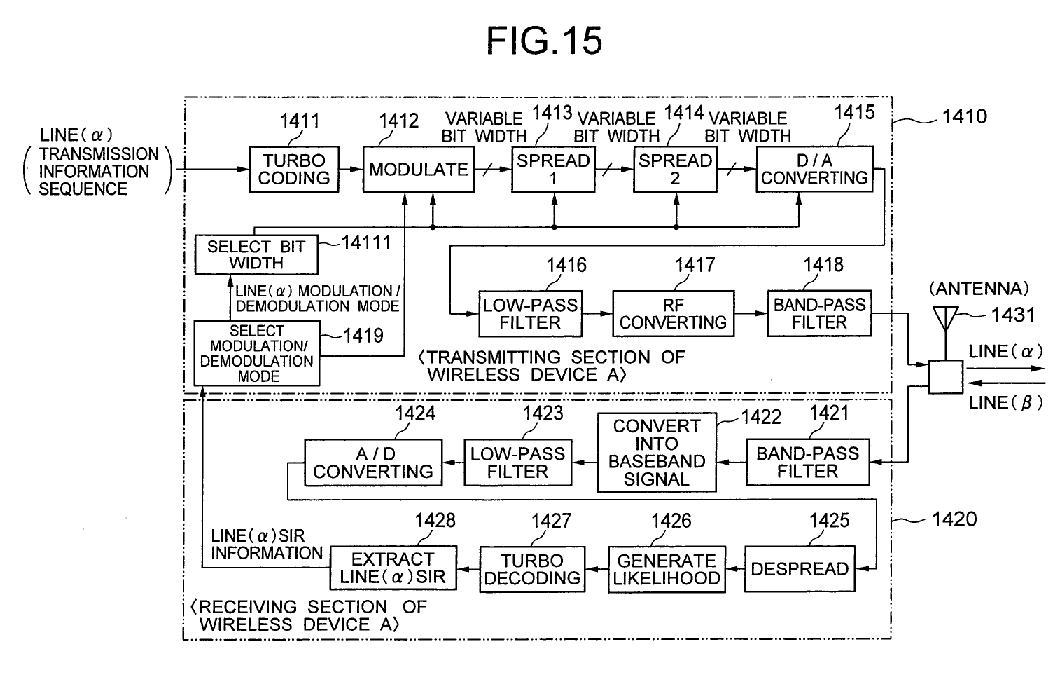

Next, an embodiment (2) will be explained as another specific example with reference to FIGS. 15 to 18.

In the embodiment (2), an example will be described where transmission and reception are performed through lines (α) and (β), and the line (α) employs an adaptive modulation/demodulation control which is corresponding to QPSK, 16 QAM, 64 QAM, and 256 QAM, as a modulation/demodulation mode, and further employs a spreading unit.

As shown in FIG. 15, a transmission side in the embodiment (2) comprises a transmitting section 1410 of a wireless device A for performing a transmitting processing for the line (α), a receiving section 1420 of the wireless device A for performing a receiving processing for the line (β), and an antenna unit 1431.

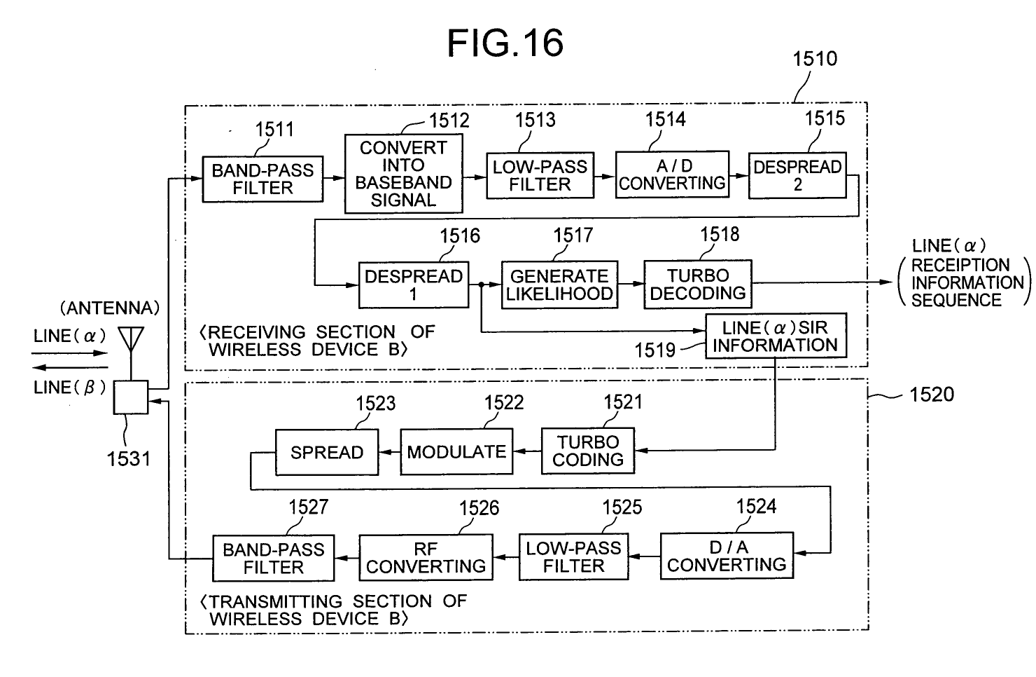

Further, as shown in FIG. 16, a reception side in the embodiment (2) comprises a receiving section 1510 of a wireless device B for performing a receiving processing for the line (α), a transmitting section 1520 of the wireless device B for performing a transmitting processing for the line (β), and an antenna unit 1531.

Next, the transmitting section 1410 of the wireless device A in the embodiment (2) will be explained with reference to FIG. 15.

The transmitting section 1410 of the wireless device A in the embodiment (2) includes a turbo coding unit 1411 as an error-correction coding unit, a modulating unit 1412 for performing QPSK, 16 QAM, 64 QAM, and 256 QAM digital modulations, a first spreading unit 1413 for spreading a transmission signal with a spread code, a second spreading unit 1414 for spreading a transmission signal with a spread code different from the spread code of the first spreading unit, a DA converting unit 1415, a low-pass filtering unit 1416, a RF converting unit 1417, and a band-pass filtering unit 1418.

Further, the transmitting section 1410 of the wireless device A includes a modulation/demodulation mode selecting unit 1419 for selecting a modulation/demodulation mode with reference to an SIR of the line (α) inputted from the receiving section 1420 of the wireless device A, a modulating unit 1412 in the transmitting section 1410 of the wireless device A which is corresponding to the modulation/demodulation mode inputted from the modulation/demodulation mode selecting unit 1419, and a bit width selecting unit 14111 for selecting a signal bit width of the modulating unit 1412, the first spreading unit 1413, the second spreading unit 1414, and the DA converting unit 1415.

Here, performances of each unit in the transmitting section 1410 of the wireless device A described above may be programmed to be executed on a computer.

The following is an explanation for the receiving section 1420 of the wireless device A in the embodiment (2).

The receiving section 1420 of the wireless device A includes a band-pass filtering unit 1421, a baseband signal converting unit 1422, a low-pass filtering unit 1423, an AD converting unit 1424, an despreading unit 1425, a likelihood generating unit 1426, a turbo decoding unit 1427, and a line (α) SIR extracting unit 1428 for extracting an SIR of the line (α) from a decoded bit stream.

Next, the receiving section 1510 of the wireless device B will be explained with reference to FIG. 16.

The receiving section 1510 of the wireless device B includes a band-pass filtering unit 1511, a baseband signal converting unit 1512, a low-pass filtering unit 1513, an AD converting unit 1514, a second despreading unit 1515 for despreading using the same spreading code as the one of the second spreading unit 1414 of the transmitting section 1410 of the wireless device A, a first despreading unit 1516 for despreading using the same spreading code as the one of the first spreading unit 1413, a likelihood generating unit 1517 corresponding to QPSK, 16 QAM, 64 QAM, and 256 QAM, a turbo decoding unit 1518, a line (α) SIR measuring unit 1519 for measuring a signal-to-interference power ratio of the line (α) as a transmission path condition of the line (α).

Here, performances of each unit in the receiving section 1510 of the wireless device B described above may be programmed to be executed on a computer.

Further, the transmitting section 1520 of the wireless device B will be explained with reference to FIG. 16.

The transmitting section 1520 of the wireless device B includes a turbo coding unit 1521, a modulating unit 1522, a spreading unit 1523, a DA converting unit 1524, a low-pass filtering unit 1525, a RF converting unit 1526, and a band-pass filtering unit 1527.

Here, performances of each unit in the transmitting section 1520 of the wireless device B described above may be programmed to be executed on a computer.

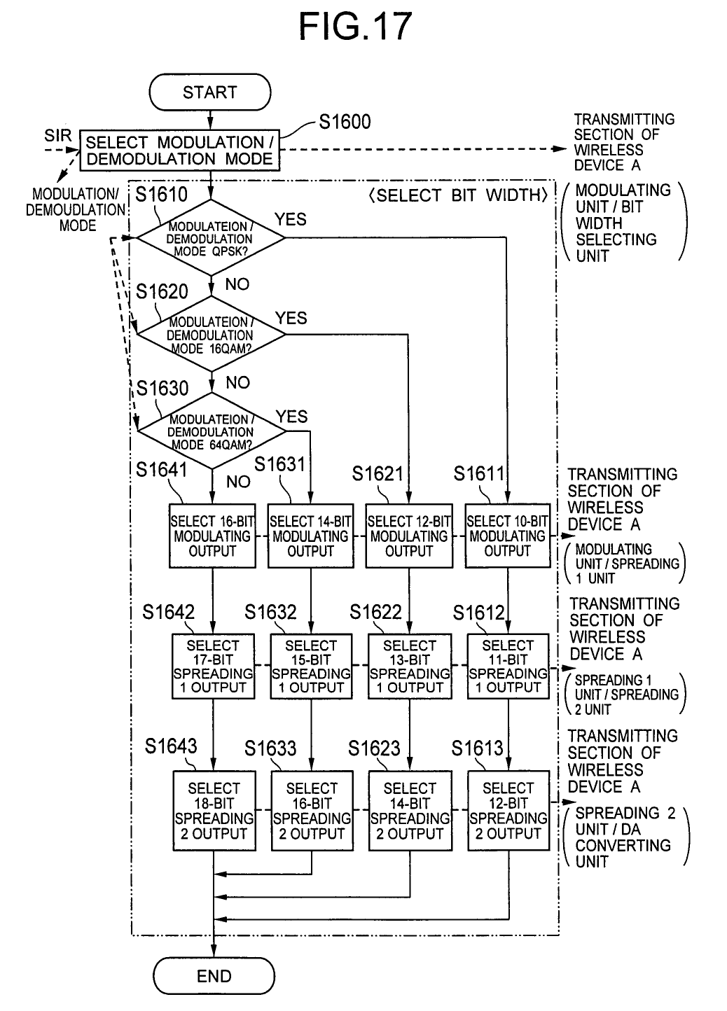

Next, with reference to a flowchart in FIG. 17, an operation in the embodiment (2) will be explained in which bit widths in the transmitting section 1410 of the wireless device A are selected.

A modulation/demodulation mode of the line (α) is selected in the determining step S1600 with reference to an SIR of the line (α) inputted from the SIR extracting unit 1428 in the receiving section 1420 of the wireless device A, and the selected modulation/demodulation mode is outputted to the modulating unit 1412 and the bit width selecting unit 14111.

When the selected modulation/demodulation mode is QPSK, a modulating output bit width selecting unit step S1611 is performed. When it is not QPSK, the processing proceeds to the next determining step S1620.

In the modulating output bit width selecting unit step S1611, a bit width for the modulating unit after digital modulation is set in 10-bit when the modulation/demodulation mode in step S1610 is QPSK, and the selected bit width is outputted to the modulating unit 1412 and the first spreading unit 1413 in the transmitting section 1410 of the wireless device A.

Following that, in a first spreading unit output bit width selecting unit step S1612, an output bit width for the first spreading unit 1413 is set in 11-bit, and the bit width is outputted to the first spreading unit 1413 and the second spreading unit 1414 in the transmitting section 1410 of the wireless device A.

Next, in a second spreading unit output bit width selecting unit step S1613, an output bit width for the second spreading unit 1414 is set in 12-bit, and the bit width is outputted to the second spreading unit 1414 and the DA converting unit 1415 in the transmitting section 1410 of the wireless device A.

When the modulation/demodulation mode is not QPSK in the determining step S1610, the processing proceeds to a determining step S1620 to determine if the modulation/demodulation mode is 16 QAM. When it is 16 QAM, a modulating output bit width selecting unit S1621 is performed. When it is not 16 QAM, the processing proceeds to determining step S1630.

When the modulation/demodulation mode is 16 QAM in the determining step S1620, a bit width for the modulating unit 1412 after digital modulation is set in 12-bit, and the selected bit width is outputted to the modulating unit 1412 and the first spreading unit 1413 in the transmitting section 1410 of the wireless device A, in the modulating output bit width selecting unit S1621.

Then, in a first spreading unit output bit width selecting unit step S1622, an output bit width for the first spreading unit 1413 is set in 13-bit, which is outputted to the first spreading unit 1413 and the second spreading unit 1414 in the transmitting section 1410 of the wireless device A.

Next, in a second spreading unit output bit width selecting unit step S1623, an output bit width for the second spreading unit 1414 is set in 14-bit, which is outputted to the second spreading unit 1414 and the DA converting unit 1415 in the transmitting section 1410 of the wireless device A.

When the modulation/demodulation mode is not 16 QAM in the determining step S1620, the next is the determining step S1630 where it is determined if the modulation/demodulation mode is 64 QAM. When it is 64 QAM, a modulating output bit width selecting unit step S1631 is performed. When it is not 64 QAM, a modulating/demodulating output bit width selecting unit step S1641 for 256 QAM modulation/demodulation mode is performed.

When the modulation/demodulation mode is 64 QAM in the determining step S1630, the modulating output bit width selecting unit S1631 is performed to set a bit width for the modulating unit 1412 after digital modulation in 14-bit, and the selected bit width is outputted to the modulating unit 1412 and the first spreading unit 1413 in the transmitting section 1410 of the wireless device A.

Further, a first spreading unit output bit width selecting unit step S1632 is performed to set an output bit width for the first spreading unit 1413 in 15-bit, and the bit width is outputted to the first spreading unit 1413 and the second spreading unit 1414 in the transmitting section 1410 of the wireless device A.

Following that, the second spreading unit output bit width selecting unit step S1633 is performed to set an output bit width of the second spreading unit 1414 in 16-bit, which is outputted to the second spreading unit 1414 and the DA converting unit 1415 in the transmitting section 1410 of the wireless device A.

When the modulation/demodulation mode is not 64 QAM in the determining step S1630, a modulating output bit width selecting unit step S1641 is performed to set a bit width for the modulating unit 1412 after digital modulation in 16-bit, and the selected bit width is outputted to the modulating unit 1412 and the first spreading unit 1413 in the transmitting section 1410 of the wireless device A.

Next, a first spreading unit output bit width selecting unit step S1642 is performed to set an output bit width of the first spreading unit 1413 in 17-bit, which is outputted to the first spreading unit 1413 and the second spreading unit 1414 in the transmitting section 1410 of the wireless device A.

Further, a second spreading unit output bit width selecting unit step S1643 is performed to set an output bit width of the second spreading unit 1414 in 18-bit, which is outputted to the second spreading unit 1414 and the DA converting unit 1415 in the transmitting section 1410 of the wireless device A.

The modulating unit 1412, the first spreading unit 1413, the second spreading unit 1414, and the DA converting unit 1415 in the transmitting section 1410 of the wireless device A input a signal, process the signal, and output a processed result in accordance with each input/output bit width inputted from the bit width selecting unit 14111.

The selected bit widths are reflected to bit widths at digital signal processing section in the transmitting section 1410 of the wireless device A with each wireless frame or each of a plurality of wireless frames.

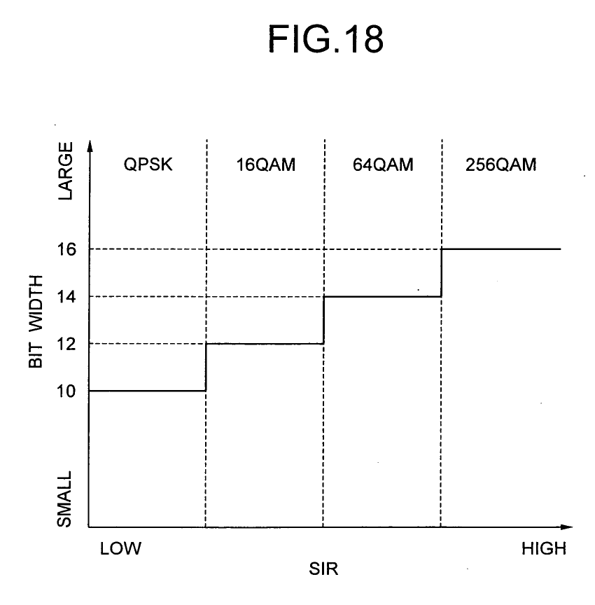

A relationship of a modulation/demodulation mode, an SIR, and a modulating output bit width is shown in FIG. 18 as an example. The larger a modulation/demodulation multiple value number of the modulation/demodulation mode is, the more a bit width for a modulating output is extended. The smaller the modulation/demodulation multiple value number is, the more the modulating output bit width is reduced, so that power consumption of the digital signal processing section in the transmitting section of the wireless device A is reduced.

In the embodiments (1) and (2) described above, the SIR is used as a transmission path condition, while a bit width or a modulation/demodulation mode can be selected considering a bit error rate, a packet error rate, EVM (modulation accuracy), delay spread, a Doppler frequency, and the like as well as the SIR. Further, it can be applicable to the other modulation/demodulation modes, such as BPSK, 8PSK as an adaptive modulation/demodulation mode.

A signal processing unit can be added or removed to/from the transmitting section and the receiving section of the wireless device A, and the receiving section and the transmitting section of the wireless device B in response to a wireless communication system for the lines (α) and (β), and the number of signal processing units is not limited in this case. Moreover, the number of variable patterns for the bit width has been described as four, however, the number of variable patterns for the bit width is not limited as well.

As described, the present invention can be embodied with various patterns.

Accordingly, for example, the number of bits for a digital signal process on the transmission side is increased/reduced in response to a transmission path condition or a modulation/demodulation mode selected based on the transmission path condition, so that power consumption can be lowered for a digital signal processing section, as described, and thereby call duration, data traffic, and standby time can be increased especially in the case with a portable terminal such as a mobile telephone system having a finite power supply like a battery.

Normally, a signal can be highly accurate because of a small effect of quantization when a digital signal processing circuit has a large number of bits, however, it increases the number of active circuit elements. Consequently, power consumption is increased. Contrary to that, a small number of bits can lead to low power consumption of the digital signal processing circuit although signal accuracy declines due to quantization noise.

When a wireless communication system is required to maintain a certain communication quality of such as throughput with utilizing the relationship between the power consumption and the signal accuracy, the power consumption can be lowered in a digital signal processing circuit while maintaining a communication quality of such as throughput by reducing the number of bits of a digital signal processing circuit on a transmission side when a transmission path is in good condition, while increasing the number of bits when a transmission path is in bad condition.

On the other hand, when it is the case with a wireless communication system in which transmitting capacity is increased intensively when a transmission path is in good condition, the power consumption of the digital signal processing circuit can be lowered by increasing the number of bits of the digital signal processing on the transmission side when a transmission path is in good condition, while reducing the number of bits of the digital signal processing on the transmission side when a transmission path is in bad condition.

### INDUSTRIAL APPLICABILITY

The present invention can be applied to a mobile station apparatus and a base station apparatus for wireless communication in which a transmission path condition is varies, and besides, the present invention can be applied to satellite communication, fixed wireless communication, and optical wireless communication. Therefore, it is usable broadly in a wireless communication field.

What is claimed is:

1. A wireless communication system comprising a digital signal processing unit in a transmitting section on a transmission side, by which a signal is processed for digital transmission or analog transmission and transmitted to a reception side through a line in order to perform communication,
wherein
a bit width selecting unit is established with the digital signal processing unit for varying a bit width for signal processing of the digital signal processing unit in response to a transmission path condition of the line from the reception side.

2. A wireless communication system comprising a digital signal processing unit in a transmitting section on a transmission side, by which a signal is processed for digital transmission or analog transmission and transmitted to a reception side through a line in order to perform communication,
wherein
the reception side has:
a transmission path condition measuring unit for measuring a transmission path condition of the line, and
a transmission path condition reversely transmitting unit for transmitting a measured condition of the transmission path to the transmission side using a reverse line with respect to the above described line; and
the transmission side has:
a bit width selecting unit for varying a bit width for signal processing of the digital signal processing unit in response to a transmission path condition of the line which is notified by the transmission path condition reversely transmitting unit on the reception side through the reverse line.

3. The wireless communication system as claimed in claim 1, wherein
the digital signal processing unit in the transmitting section on the transmission side includes:
a modulating unit, and
a digital/analog converting unit, in each of which the signal processing is performed with a signal bit width variably set by the bit width selecting unit.

4. The wireless communication system as claimed in claim 2, wherein
the transmission path condition measuring unit on the reception side includes a function of determining a transmission path condition of the line based on a signal-to-interference power ratio, and
a signal-to-interference power ratio signal bit width selecting unit is established with the digital signal processing unit in the transmitting section on the transmission side for selecting a signal bit width for the digital signal processing unit in response to a determined result of the transmission path condition of the line based on the signal-to-interference power ratio which is transmitted from the reception side.

5. The wireless communication system as claimed in claim 2, wherein
the transmitting section on the transmission side includes:
a modulation/demodulation mode selecting unit for selecting a modulation/demodulation mode of the line in response to a transmission path condition of the line which is transmitted from the reception side, and
a modulation/demodulation mode signal bit width selecting unit for selecting a signal bit width for the signal processing unit in the transmitting section on the transmission side in response to the modulation/demodulation mode selected by the modulation/demodulation mode selecting unit,
both of which are established with the digital signal processing unit.

6. A wireless communication method for performing communication by digital transmission or analog transmission of a transmission signal which has been digital signal processed, the method comprising:
a digital signal processing step of performing a digital signal processing of a transmission signal in a transmitting section on a transmission side;
a transmitting step of performing communication by digital transmission or analog transmission of a signal processed in the digital signal processing step through a line;
a transmission path condition measuring step of measuring a transmission path condition of the line on a reception side,
a transmission path condition transmitting step of transmitting the transmission path condition measured in the transmission path condition measuring step to the transmission side using a reverse line with respect to the above described line; and
a signal bit width selecting step of varying a processing signal bit width for the digital signal processing step on the transmission side in response to the transmission path condition of the line notified by the transmission path condition transmitting step through the reverse line.

7. The wireless communication method as claimed in claim 6, wherein
the digital signal processing step in the transmitting section on the transmission side includes:
a modulating step of modulating a signal, and a digital/analog converting step of digital/analog converting a signal modulated in the modulating step, in each of which signal processing is performed with a signal bit width variably set in the signal bit width selecting step.

8. The wireless communication method as claimed in claim 6, wherein the transmission path condition is determined based on a signal-to-interference power ratio with respect to the transmission signal of the line in the transmission path condition measuring step.

9. The wireless communication method as claimed in claim 6, wherein
the transmitting section on the transmission side includes a modulation/demodulation mode selecting step of selecting a modulation/demodulation mode of the line in response to a transmission path condition of the line from the reception side, and
the signal bit width selecting step varies a processing signal bit width in the digital signal processing step in response to a modulation/demodulation mode selected in the modulation/demodulation mode selecting step.

10. A signal processing program for wireless communication causing a computer on a transmission side to execute:
a digital signal processing function of performing digital signal processing to a signal for transmission on a transmission side of a wireless communication system;
a transmitting function of performing communication by digital transmission or analog transmission of a signal processed by the digital signal processing function through a line; and
a signal bit width selecting function of varying a processing signal bit width in the digital signal processing function in response to a transmission path condition of the line from a reception side through a reverse line.

11. The signal processing program for wireless communication as claimed in claim 10, wherein
the digital signal processing function on the transmission side includes:
a signal modulation function, and
a digital/analog converting function, each of which operates based on a signal bit width set in the signal bit width selecting function; and
the signal processing program for wireless communication causes a computer on the transmission side to execute each of the functions.

12. The signal processing program for wireless communication as claimed in claim 10, wherein
a transmission path condition of the line from the reception side through the reverse line is determined based on a signal-to-interference power ratio with respect to a transmission signal of the line, and
the signal bit width selecting function on the transmission side is programmed in which the signal bit width can be variably set in response to a transmission path condition depending on the ratio.

13. The signal processing program for wireless communication as claimed in claim 10, wherein
the digital signal processing function includes a modulation/demodulation mode selecting function in the transmitting section on the transmission side of selecting a modulation/demodulation mode of the line in response to a transmission path condition of the line from the reception side, and
the signal bit width selecting function is programmed in which a processing signal bit width in the digital signal processing function can be variably set in response to a modulation/demodulation mode selected in the modulation/demodulation mode selection function.
